(19) United States
(12) Patent Application Publication
(10) Pub. No.: US 2023/0139067 A1
(43) Pub. Date: May 4, 2023

(54) THERMOPLASTIC POLYESTER ELASTOMER CONJUGATE FIBER AND MANUFACTURING METHOD THEREOF AND FABRIC

(71) Applicant: NAN YA PLASTICS CORPORATION, TAIPEI (TW)

(72) Inventors: Te-Chao Liao, TAIPEI (TW); Cheng-Li Chao, TAIPEI (TW); Chao-Quan Wu, TAIPEI (TW)

(73) Assignee: NAN YA PLASTICS CORPORATION, TAIPEI (TW)

(21) Appl. No.: 17/563,074

(22) Filed: Dec. 28, 2021

(30) Foreign Application Priority Data
Nov. 2, 2021 (TW) 110140828

(51) Int. Cl. D01F 8/14; C08L 67/02; C08G 63/183; C08G 63/66; D03D 15/283

(52) U.S. Cl. CPC D01F 8/14; C08L 67/025; C08G 63/183; C08G 63/66; D03D 15/283; C08L 2203/12; C08L 2207/04; C08L 2207/20; D10B 2331/04

(57) ABSTRACT

A thermoplastic polyester elastomer conjugate fiber including a core and a sheath is provided. A volume ratio of the core to the sheath is in a range of 4:6 to 6:4.

### CROSS-REFERENCE TO RELATED APPLICATION

This application claims the priority benefit of Taiwanese application serial no. 110140828, filed on Nov. 2, 2021. The entirety of the above-mentioned patent application is hereby incorporated by reference herein and made a part of this specification.

### BACKGROUND OF THE INVENTION

### Field of the Invention

The invention relates to a conjugate fiber, a manufacturing method thereof, and a fabric, and particularly relates to a thermoplastic polyester elastomer conjugate fiber, a manufacturing method thereof, and a corresponding fabric.

### Description of Related Art

The United Nations Environment Programme (UNEP) put forward the concept of “Cleaner Production” in 1990. Cleaner Production includes the use of appropriate ratios of recycled materials in the product manufacturing process, reducing pollutants or waste, or saving energy or saving materials in the product manufacturing process, in order to achieve reasonable resource utilization.

How to reduce the one-time use of plastic materials and/or increase the ratio of recycled materials used in products has become a topic of current research.

### SUMMARY OF THE INVENTION

The invention provides a thermoplastic polyester elastomer conjugate fiber and a manufacturing method thereof and a corresponding fabric that are more eco-friendly and have better quality.

A thermoplastic polyester elastomer conjugate fiber of the invention includes a core and a sheath. A volume ratio of the core to the sheath is in a range of 4:6 to 6:4. The thermoplastic polyester elastomer conjugate fiber has the following characteristics: a denier between 120 and 150; a tenacity between 2.3 g/d and 3.4 g/d; an elongation at break between 25% and 82%; or a yarn/yarn friction coefficient between 0.043 and 0.062.

A fabric of the invention includes a plurality of the thermoplastic polyester elastomer conjugate fiber above.

A manufacturing method of a thermoplastic polyester elastomer conjugate fiber of the invention includes the following steps: providing a recycled thermoplastic polyester elastomer fiber; physically reproducing a portion of the recycled thermoplastic polyester elastomer fiber to form a physically recycled polyester material having a first intrinsic viscosity; chemically reproducing a portion of the recycled thermoplastic polyester elastomer fiber to form a chemically recycled polyester material having a second intrinsic viscosity, wherein the first intrinsic viscosity is different from the second intrinsic viscosity; mixing the physically recycled polyester material and the chemically recycled polyester material to form a recycled thermoplastic polyester material having a predetermined intrinsic viscosity; providing a virgin thermoplastic polyester material; and forming the thermoplastic polyester elastomer conjugate fiber including a core and a sheath, wherein the core is formed by the recycled thermoplastic polyester material, and the sheath is formed by the virgin thermoplastic polyester material.

Based on the above, the core of the thermoplastic polyester elastomer conjugate fiber and the manufacturing method thereof of the invention may be formed by a recycled thermoplastic polyester material. Therefore, the thermoplastic polyester elastomer conjugate fiber and the manufacturing method thereof and the corresponding fabric are more eco-friendly and may still have better quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a thermoplastic polyester elastomer conjugate fiber according to an embodiment of the invention.

FIG. 2 is a schematic partial flowchart of a manufacturing method of a thermoplastic polyester elastomer conjugate fiber according to an embodiment of the invention.

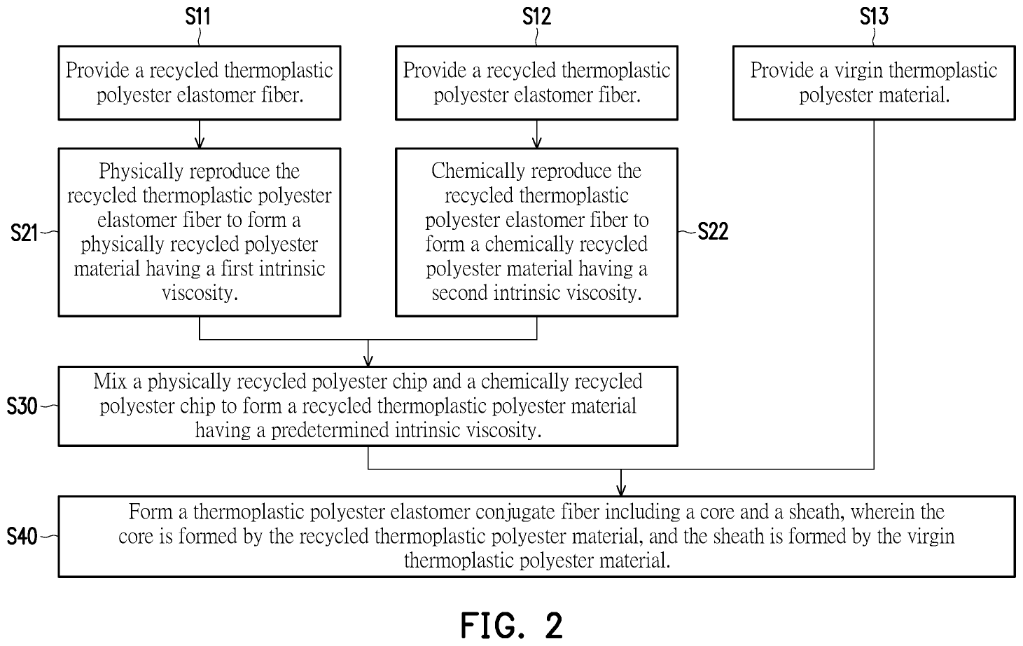

### DESCRIPTION OF THE EMBODIMENTS

In the following detailed description, for the sake of explanation and not limitation, exemplary embodiments revealing specific details are set forth to provide a thorough understanding of various principles of the invention. However, it will be obvious to those skilled in the art that, based on the disclosure, the invention may be practiced in other embodiments that depart from the specific details disclosed herein. In addition, descriptions of well-known devices, methods, and materials may be omitted so as not to obscure the description of various principles of the invention.

A range may be expressed herein as from “about” one specific value to “about” another specific value, and may also be directly expressed as one specific value and/or to another specific value. When expressing the range, another embodiment includes from the one specific value and/or to another specific value. Similarly, when a value is expressed as an approximation by using the antecedent “about”, it will be understood that the specific value forms another embodiment. It will be further understood that the endpoint of each range is obviously related to or independent of the other endpoint.

In the specification, non-limiting terms (such as possibly, may, for example, or other similar terms) are optional implementations, inclusions, additions, or existences.

Unless otherwise defined, all terms (including technical terms and scientific terms) used herein have the same meanings as those of ordinary knowledge or common understanding in the art to which the invention belongs. It will also be understood that terms (such as those defined in commonly used dictionaries) should be interpreted as having a meaning consistent with the meaning in the relevant technical context, and should not be interpreted in an idealized or overly formal sense, unless clearly defined as such herein.

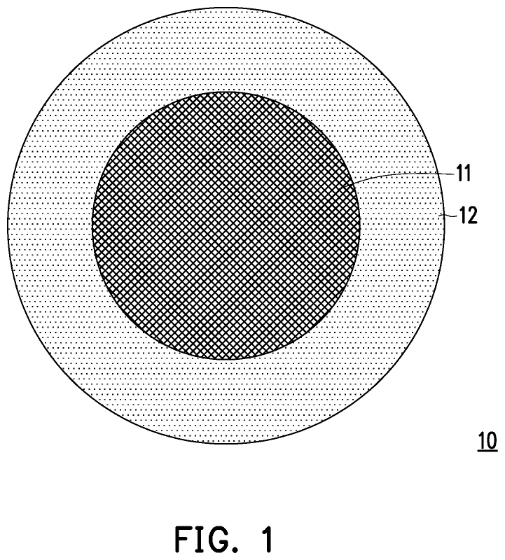

Please refer to FIG. 1, in the present embodiment, a thermoplastic polyester elastomer conjugate fiber 10 includes a core 11 and a sheath 12. Viewed from the cross-section of the thermoplastic polyester elastomer conjugate fiber 10 (as shown in FIG. 1), the sheath may wrap the core 11. In the same thermoplastic polyester elastomer conjugate fiber, the length of the core and the length of the sheath are substantially the same. Therefore, in the same thermoplastic polyester elastomer conjugate fiber, the volume of the core and the volume of the sheath may be estimated from the area of the cross section. In the same thermoplastic polyester elastomer conjugate fiber, the volume ratio of the core to the sheath is in the range of 4:6 to 6:4.

In the present embodiment and/or the content described in the following, “fiber” may mean the length is greater than 10 to 1000 times the width in the initial state thereof (that is, it has not been specially tailored for special needs). The width of the fiber is mostly between 10 μm and 1 cm. In addition, the width of the fiber may be adjusted according to the adaptive use thereof. Taking the fiber used in the fabric as an example, the width thereof may be between 10 μm and 1 mm. The length of the fiber may have a corresponding length according to the manufacturing process, testing needs, and/or adaptive use thereof. Taking the fiber used in the fabric as an example, in the initial state of the fiber, the length thereof may be between 1 cm and 1 m. Of course, if adaptive analysis or testing (such as: section testing) needs to be performed, the fiber may also be cut to a length of 1 cm or less.

In the embodiment shown in FIG. 1, the cross-section of the fiber may appear to be circular, but the invention is not limited thereto. The cross-section of the fiber may have other possible shapes due to the processing method (such as the shape of the extrusion/spinning port or the pressure during extrusion/spinning) thereof, or the corresponding external pressure during inspection or use. In an unillustrated embodiment, the cross-section of the fiber may look like a circle, an ellipse, an ellipse-like shape, or a polygon with rounded corners.

In the embodiment shown in FIG. 1, the surface of the fiber may appear to be a smooth surface, but the invention is not limited thereto. In an unillustrated embodiment, the surface of the fiber may have an uneven or rough surface due to the processing method, inspection, or use process thereof.

In the present embodiment and/or the content described in the following, conjugate fiber refers to a fiber formed by two or more than two different components. The different components may include different materials; or, the same or similar materials, but having different physical properties (such as: different glass transition temperatures (Tg), different intrinsic viscosities (IV), different hardnesses, different elasticities, and/or different crystallization ratios). Therefore, there may be corresponding interfaces between the different components. Taking the embodiment shown in FIG. 1 as an example, the intrinsic viscosity of the sheath may be different from the intrinsic viscosity of the core.

In the embodiment shown in FIG. 1, from the perspective of the cross-section of the thermoplastic polyester elastomer conjugate fiber, the sheath and core may be concentric (may be referred to as: concentric core-sheath), but the invention is not limited thereto. In an unillustrated embodiment, the sheath and core may be non-concentric (may be referred to as: eccentric core-sheath).

In the embodiment shown in FIG. 1, the thermoplastic polyester elastomer conjugate fiber may include a single sheath and a single core, but the invention is not limited thereto. In an unillustrated embodiment, the thermoplastic polyester elastomer conjugate fiber may be a single sheath that wraps a plurality of cores. In an unillustrated embodiment, the sheath may also be a multilayer structure.

The manufacturing method of the thermoplastic polyester elastomer conjugate fiber in the present embodiment is illustrated as follows.

[Recycled Thermoplastic Polyester Elastomer Fiber]

Thermoplastic polyester elastomer (TPEE) fibers are commonly found in products sold in the general market. The products include, but are not limited to, the following products: fabrics (such as elastic clothing or functional clothing) or shoes (such as elastic shoes or functional shoes).

The recycling method of thermoplastic polyester elastomer fibers includes, for example, collecting various types of waste containing thermoplastic polyester elastomer fibers (including commercial waste or industrial waste); and corresponding classifications may be made according to the type, color, and/or previous purpose of the waste, but the invention is not limited thereto.

Due to corresponding product requirements, commercial waste may include corresponding objects (such as metal particles, color blocks, labels, and/or adhesives). Therefore, the commercial waste may be pre-treated by physical treatment (such as mechanical crushing, but not limited) and/or chemical treatment (such as pickling, but not limited). Then, the thermoplastic polyester elastomer fiber is separated by a suitable method (such as flotation) and dried, so that treated recycled thermoplastic polyester elastomer fiber may be obtained.

Industrial waste may be scrap or leftovers generated during the manufacturing process of thermoplastic polyester elastomer fibers. These industrial wastes may also be recycled, and processed recycled thermoplastic polyester elastomer fibers may be obtained.

It should be mentioned that, the term “thermoplastic polyester elastomer” in the present specification may include a thermoplastic polyester elastomer for which the hard segment is polybutylene terephthalate-type (PBT-type) or a thermoplastic polyester elastomer for which the hard segment is polyethylene terephthalate-type (PET-type). The thermoplastic polyester elastomer having a PBT-type hard segment may be formed by terephthalic acid (TPA), 1,4-butylene glycol (1,4-BG), and polytetramethylene ether glycol (PTMEG). The thermoplastic polyester elastomer having a PET-type hard segment may be formed by terephthalic acid (TPA), ethylene glycol (EG), and polytetramethylene ether glycol (PTMEG). In the present embodiment, the thermoplastic polyester elastomer is preferably a PBT-type thermoplastic polyester elastomer.

[Formation of Physically Recycled Polyester Material]

In an embodiment, the recycled thermoplastic polyester elastomer fiber may be melted to make it appear as a melt in a molten state. Then, the melt may be filtered via a filter to eliminate possible solid impurities. Next, the filtered melt may be extruded and pelletized via an extruder (such as a commercially available single-screw extruder (SSE), twin-screw extruder (TSE), or other similar screw extruders, but not limited) to form a physically recycled polyester material.

In an embodiment, before the recycled thermoplastic polyester elastomer fiber is melted, it may be made into powder or pellets by cutting, shearing, trimming, or other physical methods to reduce the time and/or energy consumption needed for melting.

Moreover, the method above is to reshape the recycled thermoplastic polyester elastomer fiber via the steps of cutting, melting, filtering, and extrusion. In other words, the physically recycled polyester material is substantially formed by rearranging the polyester molecules in the recycled thermoplastic polyester elastomer fiber.

In the present embodiment, in the physical reproduction process, the polyester molecules therein are substantially only rearranged (that is, substantially not reorganized). Therefore, the components (such as additives, slip agents, stabilizers, and/or polymerization catalysts) originally present in the recycled thermoplastic polyester elastomer fiber are still present in the physically recycled polyester material. That is to say, some of the characteristics of the physically recycled polyester material may be the same as or similar to some of the characteristics of the original recycled thermoplastic polyester elastomer fiber.

The physically recycled polyester material produced by the physical reproduction process usually has a higher intrinsic viscosity (compared to the chemically recycled polyester material described later). In the present embodiment, the intrinsic viscosity of the physically recycled polyester material is usually less than 1.50 dL/g.

In an embodiment, to adjust the intrinsic viscosity of the physically recycled polyester material, solid-state polymerization may be used. However, the solid-state polymerization method more readily increases the intrinsic viscosity of the physically recycled polyester material, and may not be used to reduce the intrinsic viscosity of the physically recycled polyester material.

[Formation of Chemically Recycled Polyester Material]

Step 1-1: in an embodiment, the recycled thermoplastic polyester elastomer fiber may be chemically depolymerized. For example, the recycled thermoplastic polyester elastomer fiber and the depolymerization liquid may be put into a depolymerization tank for chemical depolymerization.

The chemical depolymerization liquid may substantially sever the polyester molecules in the recycled thermoplastic polyester elastomer fiber, thereby achieving the effect of depolymerization. Moreover, a polyester composition having a shorter molecular chain and/or an ester monomer formed by one diacid unit (such as TPA) and a plurality of diol units (1,4-BG, PTMEG, or a combination of the above; or, EG, PTMEG, or a combination of the above) may be obtained. That is, the average molecular weight of the mixture after chemical depolymerization is substantially less than the average molecular weight of the recycled polyester material.

In addition, the invention does not limit the type of depolymerization liquid. For example, hydrolysis may be performed by water. As another example, alcoholysis may be performed via an alcohol (such as methanol, ethanol, EG, diethylene glycol, 1,4-BG, or a mixture of the above).

In an embodiment, the depolymerization liquid is preferably an alcohol. Generally, alcohols that may be used to produce reactive monomers in virgin chips are preferred. In the case of a recycled thermoplastic polyester elastomer fiber including a PBT-type thermoplastic polyester elastomer, 1,4-BG may be used as the depolymerization liquid. In the case of a recycled thermoplastic polyester elastomer fiber including a PET-type thermoplastic polyester elastomer, EG may be used as the depolymerization liquid.

When a chemical depolymerization reaction is performed, a heating step may be suitably performed. Generally speaking, heating may accelerate the progress of chemical reactions. For example, after the recycled thermoplastic polyester elastomer fiber and alcohol are put into the depolymerization tank, an alcoholysis reaction may be performed at a temperature of 190° C. to 240° C. for about three hours.

Step 1-2: esterification reaction.

The product from the chemical depolymerization reaction is subjected to an esterification reaction. It is worth noting that the invention does not limit all polyester materials to be completely depolymerized.

For example, the product from the chemical depolymerization reaction may be transferred to an esterification tank for esterification reaction. The esterification reaction is generally a reversible reaction. Therefore, at the same time that the esterification reaction is performed, the depolymerization liquid and/or a portion of the product (such as alcohol and/or water) may be brought out by distillation. In this way, the amount or concentration of other products (such as polyester products) may be increased via chemical equilibrium.

In an embodiment, before the product from the chemical depolymerization reaction is moved into the esterification tank, the product may be filtered via a filter screen first so that at least a portion of the impurities may be removed, thereby reducing the concentration of non-polyester impurities. In an embodiment, the pore size of the filter screen may be between 1 μm and 20 μm.

In a potential embodiment, after the esterification reaction is performed for a period of time, a suitable or suitable amount of additives may be added to the esterification tank, but the invention is not limited thereto. Other additives may include antioxidants, stabilizers, and/or polymerization catalysts.

Step 1-3: polymerization reaction.

The product from the esterification reaction is subjected to a polymerization reaction.

For example, the product from the esterification reaction may be transferred to a polymerization tank for polymerization reaction.

The polymerization reaction may include a pre-polymerization reaction and/or a main polymerization reaction.

The pre-polymerization reaction is, for example, to reduce the gas pressure in the tank within a period of time. For example, the air pressure in the tank may be reduced from normal pressure (e.g., about 760 torr) to 1 torr within 60 minutes via a suction pump; or, it may be further reduced to 1 torr or less (e.g., 1 torr or close to 1 torr).

The main polymerization reaction is, for example, heating the substance in the tank under low pressure (for example, lower than the room pressure). For example, the polymerization reaction may be performed at a temperature of 270° C. to 290° C. under the condition that the pressure in the tank is 1 torr or less.

Step 1-4: a chemically recycled polyester material is formed.

The polymerization reaction is performed until the substance in the tank has a corresponding intrinsic viscosity. Then, the air pressure in the tank may be increased (for example, filling nitrogen gas). Then, for example, the substance in the tank may be extruded and/or pelletized by a commonly used pelletizing method for general polymer chips to form a chemically recycled polyester material.

In the present embodiment, the chemically recycled polyester material formed by the chemical reproduction process generally has a lower intrinsic viscosity (compared to the physically recycled polyester material). In the present embodiment, the intrinsic viscosity is usually not more than 1.30 dL/g.

[Formation of Recycled Thermoplastic Polyester Material]

The physically recycled polyester material and the chemically recycled polyester material may be mixed to form a recycled thermoplastic polyester material having a predetermined intrinsic viscosity. Compared with the physically recycled polyester material, the chemically recycled polyester material has more production cost and/or longer production time. Compared with the chemically recycled polyester material, the material characteristics of the physically recycled polyester material (such as intrinsic viscosity, but not limited) are more difficult to adjust. Therefore, by mixing the physically recycled polyester material and the chemically recycled polyester material, the production cost of the recycled thermoplastic polyester material may be reduced and/or the production time may be shortened, and the characteristics of the material may still be adjusted appropriately.

In an embodiment, the powdered or granular physically recycled polyester material and chemically recycled polyester material may be directly mixed according to a suitable ratio to form the recycled thermoplastic polyester material.

In an embodiment, the physically recycled polyester material and the chemically recycled polyester material may form the recycled thermoplastic polyester material via a granulation step of melting and extrusion by an extruder.

In an embodiment, the characteristics of the recycled thermoplastic polyester material may be between the physically recycled polyester material and the chemically recycled polyester material. For example, the intrinsic viscosity of the recycled thermoplastic polyester material may have a corresponding linear relationship or near-linear relationship according to the ratios and intrinsic viscosities of the physically recycled polyester material and the chemically recycled polyester material.

[Formation of Thermoplastic Polyester Elastomer Conjugate Fiber]

The thermoplastic polyester elastomer conjugate fiber of the present embodiment may be formed by the same or similar forming method as that of a general core-sheath-type conjugate fiber.

In the thermoplastic polyester elastomer composite fiber of the present embodiment, the material forming the core may include a recycled thermoplastic polyester material. In an embodiment, the recycled thermoplastic polyester material used to form the core includes a physically recycled polyester material and a chemically recycled polyester material. In an embodiment, in the recycled thermoplastic polyester material used to form the core, the weight ratio of the chemically recycled polyester material is greater than or equal to the physically recycled polyester material. In this way, the intrinsic viscosity of the core may lower.

In the thermoplastic polyester elastomer composite fiber of the present embodiment, the material forming the core may include the recycled thermoplastic polyester material and a virgin thermoplastic polyester material.

In an embodiment, in the recycled thermoplastic polyester material used to form the core, the weight ratio of the virgin thermoplastic polyester material is greater than or equal to 40 wt %. In this way, the resulting thermoplastic polyester elastomer conjugate fiber may have better quality.

In an embodiment, in the recycled thermoplastic polyester material used to form the core, the weight ratio of the virgin thermoplastic polyester material is greater than or equal to 40 wt % and less than or equal to 60 wt %. In this way, the resulting thermoplastic polyester elastomer conjugate fiber may have better quality, and the recycled thermoplastic polyester material may be effectively used, and/or be more eco-friendly.

In an embodiment, the virgin thermoplastic polyester material may be formed by a corresponding reactant (such as TPA, 1,4-BG, and PTMEG; or, TPA, EG, and PTMEG) in a suitable reaction (such as an esterification reaction). In an embodiment, the virgin thermoplastic polyester material may be purchased from the market.

For example, a commonly used fiber spinning process may be used to form a filamentary core. Then, the filamentary core is passed through an extrusion coating device, so that the molten virgin thermoplastic polyester material covers the filamentary core. Next, via a suitable cooling step, a thermoplastic polyester elastomer conjugate fiber having a core and a sheath is formed.

In an embodiment, the core may have a corresponding cross-sectional area via the spinning speed in the fiber spinning process. In an embodiment, via the shape of the spinning opening in the fiber spinning process, the core may have a corresponding cross-sectional shape.

In an embodiment, the speed at which the filamentary core passes through the extrusion coating device may make the core and sheath have a corresponding volume ratio.

In an embodiment, the volume ratio of the core to the sheath is between 4:6 and 6:4, the viscosity of the core is greater than 1 dL/g, and/or the viscosity of the sheath is greater than 1 dL/g. In this way, the thermoplastic polyester elastomer conjugate fiber may be less readily broken, and may be applied to fabric (for example: after being applied to fabric, the thermoplastic polyester elastomer conjugate fiber is less prone to deformation, is lighter, and/or comfortable).

The thermoplastic polyester elastomer conjugate fiber may be stored by winding; or, the thermoplastic polyester elastomer conjugate fiber may be further sold and/or used.

In brief, as shown in FIG. 3, the manufacturing method of the thermoplastic polyester elastomer conjugate fiber may include the following steps. Step S11 or step S12: a recycled thermoplastic polyester elastomer fiber is provided. Step S13: a virgin thermoplastic polyester material is provided. Step S21: the recycled thermoplastic polyester elastomer fiber is physically reproduced to form a physically recycled polyester material having a first intrinsic viscosity. Step S22: the recycled thermoplastic polyester elastomer fiber is chemically reproduced to form a chemically recycled polyester material having a second intrinsic viscosity. Step S30: a physically recycled polyester chip and a chemically recycled polyester chip are mixed to form a recycled thermoplastic polyester material having a predetermined intrinsic viscosity. Step S40: a thermoplastic polyester elastomer conjugate fiber including a core and a sheath is formed. The material forming the core includes a recycled thermoplastic polyester material, and the material forming the sheath includes a virgin thermoplastic polyester material.

In an embodiment, the material forming the core includes a recycled thermoplastic polyester material and a virgin thermoplastic polyester material, and the material forming the sheath is a virgin thermoplastic polyester material.

In an embodiment, the denier of the thermoplastic polyester elastomer conjugate fiber may be greater than 100. In this way, the thermoplastic polyester elastomer conjugate fiber may be more resistant to wear, and may be less readily broken when used as a fabric. In an embodiment, the denier of the thermoplastic polyester elastomer conjugate fiber may be greater than 100 and less than 200. In this way, the thermoplastic polyester elastomer conjugate fiber may be more portable when used as a fabric.

In an embodiment, the tenacity of the thermoplastic polyester elastomer conjugate fiber may be greater than 2.0 grams per denier (g/d).

In an embodiment, the elongation at break of the thermoplastic polyester elastomer conjugate fiber may be less than 100%. In this way, the thermoplastic polyester elastomer conjugate fiber may be more suitable for fabrics, and/or less prone to deformation. In an embodiment, the elongation at break of the thermoplastic polyester elastomer conjugate fiber may be between 10% and 90%.

In an embodiment, the coefficient of friction (which may be referred to as: yarn/yarn friction coefficient) between a plurality of thermoplastic polyester elastomer conjugate fibers may be less than 0.080. In this way, the thermoplastic polyester elastomer conjugate fiber is more comfortable when used as a fabric.

### Examples and Comparative Examples

Examples and comparative examples are shown below to illustrate the invention in detail, but the invention is not limited by the following examples at all.

In each example and comparative example, the corresponding thermoplastic polyester elastomer conjugate fiber may be formed by the above method. The recycled thermoplastic polyester material used in the core of the thermoplastic polyester elastomer conjugate fiber may be formed by the method above, and the virgin thermoplastic polyester material used in the sheath of the thermoplastic polyester elastomer conjugate fiber may be the virgin thermoplastic polyester material sold by the Dutch company DSM (material number: EL550). The difference is in the volume ratio of the core to the sheath or the characteristic viscosity of the recycled thermoplastic polyester material forming the core.

The thermoplastic polyester elastomer conjugate fibers of [Example 1] to [Example 3] and [Comparative Example 1] to [Comparative Example 2] in [Table 1] were evaluated. The evaluation items are shown in [Table 1].

Strength analysis (g/d) (i.e., corresponding to the tenacity in [Table 1]): the strength of thermoplastic polyester elastic fiber was tested using a single fiber tensile tester (Yuanchuang Company, model: statimat) according to ASTM D2256 standard test method.

Elongation analysis (%) (i.e., corresponding to the elongation at break in ([Table 1]): the elongation of thermoplastic polyester elastic fiber was tested using a single fiber tensile tester (Yuanchuang Company, model: statimat) according to ASTM D2256 standard test method.

Denier (den): using a spinning machine, 90 turns were wound under the same or similar conditions each turn, and the denier of the yarn was tested after removal.

Denier=yarn weight*100.

Yarn/yarn friction coefficient: an analysis was performed using a friction coefficient tester (LENING company, model: friction measurement) according to ASTM D3108 standard test method.

Viscosity test (dL/g): 0.125 g of thermoplastic polyester elastomer (TPEE) solid was measured, dissolved in 25 ml of mixed solvent (phenol/trichloroethane), heated to 124° C., measured using an AVS370 viscosity tester (SI Analytics), with a stirring motor of 330 rpm.

TABLE 1

| | | Example | Example | Example | Comparative | Comparative |
|---|---|---|---|---|---|---|
| | | 1 | 2 | 3 | Example 1 | Example 2 |
| Core | Intrinsic viscosity (dL/g) | 1 | 1.1 | 1.2 | 1.4 | 1.3 |
| | Weight-average molecular | 82472 | 78452 | 77254 | 80314 | 75145 |
| | weight (Mw, g/mol) | | | | | |
| | Melting point (Tm, ° C.) | 214 | 205 | 201 | 209 | 196 |
| | Core volume ratio (%) | 50 | 60 | 40 | 80 | 90 |
| | Chemical recycling (wt %) | 40 | 30 | 20 | 10 | 20 |
| | Physical recycling (wt %) | 10 | 30 | 20 | 70 | 70 |
| Sheath | Intrinsic viscosity (dL/g) | 1.5 | 1.5 | 1.5 | 0.9 | 1.2 |
| | Sheath volume ratio (%) | 50 | 40 | 60 | 20 | 10 |
| Thermoplastic | Denier | 150 | 140 | 120 | 100 | 100 |
| polyester | Tenacity (g/d) | 3.4 | 2.8 | 2.3 | 1.9 | 1.5 |
| elastomer | Elongation at break (%) | 82 | 25 | 46 | 120 | 180 |
| conjugate | Yam/yarn friction coefficient | 0.043 | 0.053 | 0.062 | 0.087 | 0.113 |
| fiber | | | | | | |

As shown in the above table, the thermoplastic polyester elastomer conjugate fiber may be less readily broken, and may be applied to fabric (for example: after being applied to fabric, the thermoplastic polyester elastomer conjugate fiber is less prone to deformation, lighter, and/or comfortable).

### INDUSTRIAL APPLICABILITY

The thermoplastic polyester elastomer conjugate fiber of the invention may be woven, for example, to form a fabric (such as cloth, clothing, blanket, or curtain; but not limited thereto).

Based on the above, a portion (such as the core) of the thermoplastic polyester elastomer conjugate fiber of the invention may be formed by a recycled thermoplastic polyester material. In addition, the thermoplastic polyester elastomer conjugate fiber of the invention has better quality.

What is claimed is:

1. A thermoplastic polyester elastomer conjugate fiber, comprising:
a core; and
a sheath, wherein a volume ratio of the core to the sheath is in a range of 4:6 to 6:4, and the thermoplastic polyester elastomer conjugate fiber has the following characteristics:
a denier between 120 and 150;
a tenacity between 2.3 g/d and 3.4 g/d;
an elongation at break between 25% and 82%; or
a yarn/yarn friction coefficient between 0.043 and 0.062.

2. The thermoplastic polyester elastomer conjugate fiber of claim 1, wherein an intrinsic viscosity of the core is between 1 dL/g and 1.2 dL/g.

3. The thermoplastic polyester elastomer conjugate fiber of claim 1, wherein an intrinsic viscosity of the core is different from an intrinsic viscosity of the sheath.

4. The thermoplastic polyester elastomer conjugate fiber of claim 1, wherein a material forming the core comprises a recycled material.

5. The thermoplastic polyester elastomer conjugate fiber of claim 4, wherein a material forming the sheath comprises a virgin polyester material.

6. The thermoplastic polyester elastomer conjugate fiber of claim 4, wherein the recycled material is formed by a physically recycled polyester material and a chemically recycled polyester material, and a ratio of the chemically recycled polyester material is greater than or equal to a ratio of the physically recycled polyester material.

7. A fabric, comprising a plurality of the thermoplastic polyester elastomer conjugate fiber of claim 1.

8. A manufacturing method of a thermoplastic polyester elastomer conjugate fiber, comprising:
providing a recycled thermoplastic polyester elastomer fiber;
physically reproducing a portion of the recycled thermoplastic polyester elastomer fiber to form a physically recycled polyester material having a first intrinsic viscosity;
chemically reproducing a portion of the recycled thermoplastic polyester elastomer fiber to form a chemically recycled polyester material having a second intrinsic viscosity, wherein the first intrinsic viscosity is different from the second intrinsic viscosity;
mixing the physically recycled polyester material and the chemically recycled polyester material to form a recycled thermoplastic polyester material having a predetermined intrinsic viscosity;
providing a virgin thermoplastic polyester material; and
forming the thermoplastic polyester elastomer conjugate fiber comprising a core and a sheath, wherein the core is formed by the recycled thermoplastic polyester material, and the sheath is formed by the virgin thermoplastic polyester material.
